(19) United States
(12) Patent Application Publication
(10) Pub. No.: US 2025/0125747 A1
(43) Pub. Date: Apr. 17, 2025

(54) METHOD AND DEVICE FOR CALIBRATING A POSITION SENSOR APPLIED TO A MOTOR

(71) Applicant: DONGGUAN DIRECT DRIVE TECHNOLOGY LIMITED, Dongguan (CN)

(72) Inventors: Yanan YU, Dongguan (CN); Xuanhong LIAO, Dongguan (CN); Zhenfeng LU, Dongguan (CN); Liguo SHENG, Dongguan (CN)

(73) Assignee: DONGGUAN DIRECT DRIVE TECHNOLOGY LIMITED, Dongguan (CN)

(21) Appl. No.: 18/991,750

(22) Filed: Dec. 23, 2024

Related U.S. Application Data
(63) Continuation of application No. PCT/CN2022/105532, filed on Jul. 13, 2022.

(30) Foreign Application Priority Data
Jun. 24, 2022 (CN) 202210724099.4

(51) Int. Cl. H02P 6/16; G01B 7/30

(52) U.S. Cl. CPC H02P 6/16; G01B 7/30; H02P 2203/11

(57) ABSTRACT

The present invention relates to the technical field of position calibration, and in particular to a method and a device for calibrating a position sensor applied to a motor. The method comprises acquiring absolute position information of a motor based on feedback of a PWM signal; giving an orthogonal signal to the motor; giving an electrical angle in a first direction to the motor, and recording first relative angles fed back by the orthogonal signal; acquiring a first calibration mapping table for mapping the first relative angles to the electrical angle based on a mapping relation between the first relative angles and the electrical angle; and setting the first calibration mapping table as a mapping table after position sensor calibration to perform calibration; utilizing an absolute lag angle based on feedback of a PWM signal to calibrate relative angle with relatively better real-time performance, in order to avoid step loss.

### CROSS-REFERENCE OF RELATED APPLICATION

The present disclosure is a continuation of International Patent Application No. PCT/CN2022/105532 filed on Jul. 13, 2022, which claims the priority of Chinese Patent Application 202210724099.4 filed on Jun. 24, 2022.

### FIELD

The invention relates to the technical field of position calibration, in particular to a method and a device for calibrating a position sensor applied to a motor.

### BACKGROUND

When a high-precision magnetic encoder is used as a position sensor to provide position information for a motor, communication between a motor controller and the position sensor is generally in the following three ways: the first is through SPI, the main issue being that when the position sensor is at a considerable distance from the motor controller, position information is susceptible to interference main problem that when the distance between the position sensor and the motor controller is long, position information is easily disturbed; the second is though PWM, which allows for a longer communication distance, but as the positional resolution increases, there is a significant communication lag; the third is through an orthogonal signal, which cannot provide feedback on absolute position information.

Therefore, a direct-drive motor using an orthogonal signal cannot be smoothly started; additionally, there is a possibility of step loss through the orthogonal signal.

### SUMMARY

To solve the above problems, one objective of the invention is to provide a method and a device for calibrating a position sensor applied to a motor, which solve the problems that sensor position calibration is easily disturbed and position information is inaccurate in the prior art, and utilize an absolute lag angle based on feedback of a PWM signal to calibrate relative angle with relatively better real-time performance, in order to avoid step loss.

The objective of the invention may be fulfilled by the following technical solution:

A method for calibrating a position sensor applied to a motor comprises: giving a PWM signal to a motor; obtaining absolute position information of the motor based on feedback of the PWM signal; giving an orthogonal signal to the motor; giving an electrical angle in a first direction to the motor, and recording first relative angles fed back by the orthogonal signal; acquiring a first calibration mapping table for mapping the first relative angles to the electrical angle based on a mapping relation between the first relative angles and the electrical angle; and setting the first calibration mapping table as a mapping table after position sensor calibration to perform calibration.

Details of one or more embodiments of the invention will be provided in the following drawings and description. Other features, objectives and advantages of the invention will become obvious with reference to the description, drawings and claims.

The method for calibrating a position sensor applied to a motor of the present invention solves the problems that sensor position calibration is easily disturbed and position information is inaccurate in the prior art, and comprises: acquiring the absolute position information of the motor based on feedback of the PWM signal; giving the orthogonal signal to the motor; giving the electrical angle in the first direction to the motor, and recording the first relative angles fed back by the orthogonal signal; acquiring the first calibration mapping table for mapping the first relative angles to the electrical angle based on the mapping relation between the first relative angles and the electrical angle; and setting the first calibration mapping table as the mapping table after position sensor calibration to perform calibration.

The device for calibrating a position sensor applied to a motor of the present invention solves the problems that sensor position calibration is easily disturbed and position information is inaccurate in the prior art, and specifically comprises: a first signal module adapted for giving a PWM signal to a motor; an absolute position acquisition module adapted for acquiring absolute position information of the motor based on feedback of the PWM signal; a second signal module adapted for giving an orthogonal signal to the motor; a first angle acquisition module adapted for giving an electrical angle in a first direction to the motor and recording first relative angles fed back by the orthogonal signal; a first mapping acquisition module adapted for acquiring a first calibration mapping table for mapping the first relative angles to the electrical angle based on a mapping relation between the first relative angles and the electrical angle; and a mapping table output module adapted for setting the first calibration mapping table as a mapping table after position sensor calibration to perform calibration, utilizing an absolute lag angle based on feedback of a PWM signal to calibrate relative angle with relatively better real-time performance, in order to avoid step loss.

### BRIEF DESCRIPTION OF THE DRAWINGS

The embodiments and/or examples of the invention disclosed here are better described and explained with reference to one or more accompanying drawings. Additional details or examples for describing the drawings should not be construed as limitations of the scope of any one of the invention disclosed here, the embodiments and/or examples described here, and the current optimal mode of the invention.

In the drawings:

FIG. 1 is a schematic diagram of Embodiment 1 of a method for calibrating a position sensor applied to a motor according to the invention;

FIG. 2 is a schematic diagram of Embodiment 2 of a method for calibrating a position sensor applied to a motor according to the invention;

FIG. 3 is a partial schematic diagram of Embodiment 2 of the method for calibrating a position sensor applied to a motor d according to the invention;

FIG. 4 is a schematic diagram of Embodiment 4 of a method for calibrating a position sensor applied to a motor according to the invention;

FIG. 5 is a partial schematic diagram of Embodiment 4 of a method for calibrating a position sensor applied to a motor according to the invention;

FIG. 6 is a schematic diagram of a device for calibrating a position sensor applied to a motor according to the invention;

FIG. 7 is a schematic diagram of another embodiment of the device for calibrating a position sensor applied to a motor in FIG. 6.

### DESCRIPTION OF THE EMBODIMENTS

To gain a better understanding of the invention, the invention is described more comprehensively below with reference to related drawings. Preferred embodiments of the invention are illustrated by the drawings, but the invention may be implemented in various different forms and is not limited the embodiments described below. On the contrary, these embodiments are provided to allow for a more thorough and comprehensive understanding of the contents disclosed in the invention.

Unless otherwise defined, all technical and scientific terms used here have the same meanings as commonly understood by those skilled in the technical field of the invention. All terms used here are merely for the purpose of describing specific embodiments and are not intended to limit the invention.

PWM belonging to pulse width modulation is an analogue control method, which modulates the bias of a base of a transistor or a gate of an MOS transistor to change the on-time of the transistor or the MOS transistor, so as to realize change of power output. PWM utilizes digital signals of a microprocessor to control an analog circuit.

### Embodiment 1

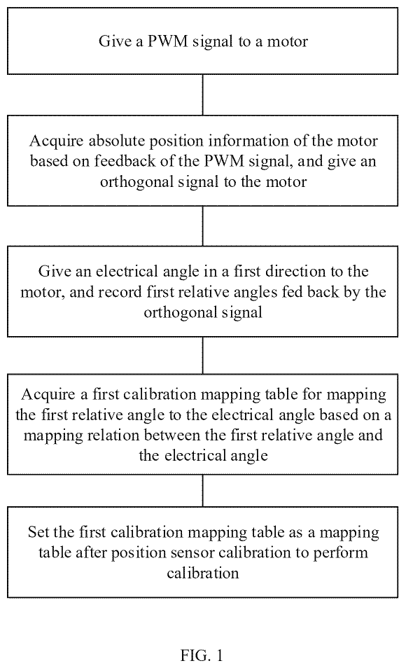

As shown in FIG. 1, an embodiment of a method for calibrating a position sensor applied to a motor is provided and comprises the following steps.

Give a PWM signal to a motor.

Acquire absolute position information of the motor based on feedback of the PWM signal, and give an orthogonal signal to the motor.

Give an electrical angle in a first direction to the motor, and record first relative angles fed back by the orthogonal signal.

Acquire a first calibration mapping table for mapping the first relative angle to the electrical angle based on a mapping relation between the first relative angle and the electrical angle.

Set the first calibration mapping table as a mapping table after position sensor calibration to perform calibration.

In this embodiment, when giving the orthogonal signal to the motor, the orthogonal signal is preferably an orthogonal differential signal, the first direction is either a forward rotation direction or a reverse rotation direction of the motor, and the first calibration mapping table is generated based on the PWM signal and the orthogonal signal in combination with the electrical angle for the motor, and the motor is calibrated by a position sensor based on the first calibration mapping table.

### Embodiment 2

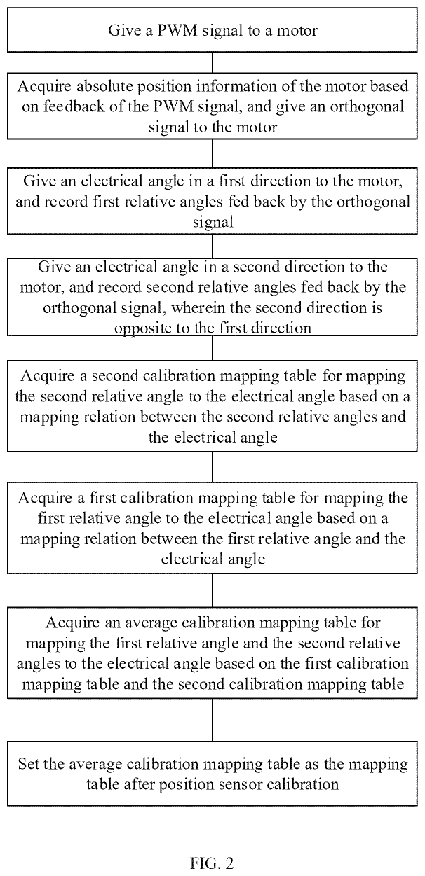

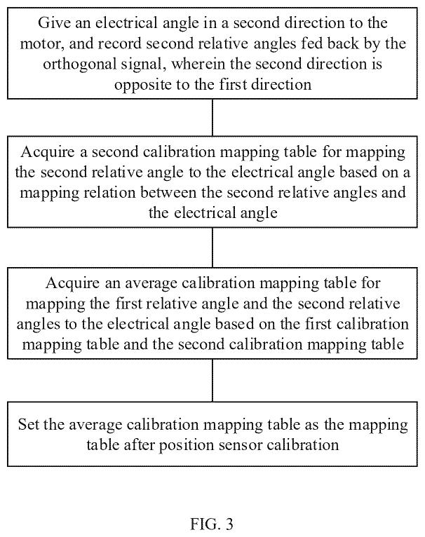

Referring to FIGS. 2-3, an embodiment of a method for calibrating a position sensor applied to a motor is provided, and comprises the following steps.

Give a PWM signal to a motor.

Acquire absolute position information of the motor based on feedback of the PWM signal, and give an orthogonal signal to the motor;

Give an electrical angle in a first direction to the motor, and record first relative angles fed back by the orthogonal signal.

Acquire a first calibration mapping table for mapping the first relative angle to the electrical angle based on a mapping relation between the first relative angle and the electrical angle.

Set the first calibration mapping table as a mapping table after position sensor calibration to perform calibration.

After giving the orthogonal signal to the motor and before outputting an angle calibration mapping table, the method further comprises the following steps.

Give an electrical angle in a second direction to the motor, and record second relative angles fed back by the orthogonal signal, wherein the second direction is opposite to the first direction.

Acquire a second calibration mapping table for mapping the second relative angle to the electrical angle based on a mapping relation between the second relative angles and the electrical angle.

The step of setting the first calibration mapping table as a mapping table after position sensor calibration comprises the following steps.

Acquire an average calibration mapping table for mapping the first relative angle and the second relative angles to the electrical angle based on the first calibration mapping table and the second calibration mapping table.

Sett the average calibration mapping table as the mapping table after position sensor calibration.

Different from Embodiment 1, in this embodiment, the relative angles in the first direction and the second direction are acquired, and the average calibration mapping table acquired by averaging the first calibration mapping table for mapping the first relative angles to the electrical angle and the second calibration mapping table for mapping the second relative angles to the electrical angle is set as the mapping table after position sensor calibration, so as to reduce a given angle error caused by the cogging torque. Compared with Embodiment 1, a more accurate calibration angle can be obtained.

### Embodiment 3

Another embodiment of a method for calibrating a position sensor applied to a motor is provided, and comprises the following steps.

Givi a PWM signal to a motor.

Acquiring absolute position information of the motor based on feedback of the PWM signal, and give an orthogonal signal to the motor;

Give an electrical angle in a first direction to the motor, and record first relative angles fed back by the orthogonal signal.

Acquire a first calibration mapping table for mapping the first relative angle to the electrical angle based on a mapping relation between the first relative angle and the electrical angle.

Set the first calibration mapping table as a mapping table after position sensor calibration to perform calibration.

After giving the orthogonal signal to the motor is given and before outputting an angle calibration mapping table, the method further comprises the following steps.

Give an electrical angle in a second direction to the motor, record second relative angles fed back by the orthogonal signal, wherein the second direction is opposite to the first direction.

Acquire a second calibration mapping table for mapping the second relative angles to the electrical angle based on a mapping relation between the second relative angles and the electrical angle.

The step of setting the first calibration mapping table as a mapping table after position sensor calibration comprises the following steps.

Acquire an average calibration mapping table for mapping the first relative angles and the second relative angles to the electrical angle based on the first calibration mapping table and the second calibration mapping table.

Set the average calibration mapping table as the mapping table after position sensor calibration.

The step of acquiring the average calibration mapping table for mapping the first relative angles and the second relative angles to the electrical angle comprises the follow steps.

Calculate third relative angles corresponding to the electrical angle in the average calibration mapping table, based on a formula xₙ=bₙ+cₙ/2, wherein x₁ . . . xₙ are the third relative angles, b₁ . . . bₙ are the first relative angles, and c₁ . . . cₙ are the second relative angles.

In this embodiment, the third relative angles corresponding to the electrical angle in the average calibration mapping table are calculated by a formula, and the average calibration mapping table is acquired to reduce a given angle error caused by the cogging torque.

### Embodiment 4

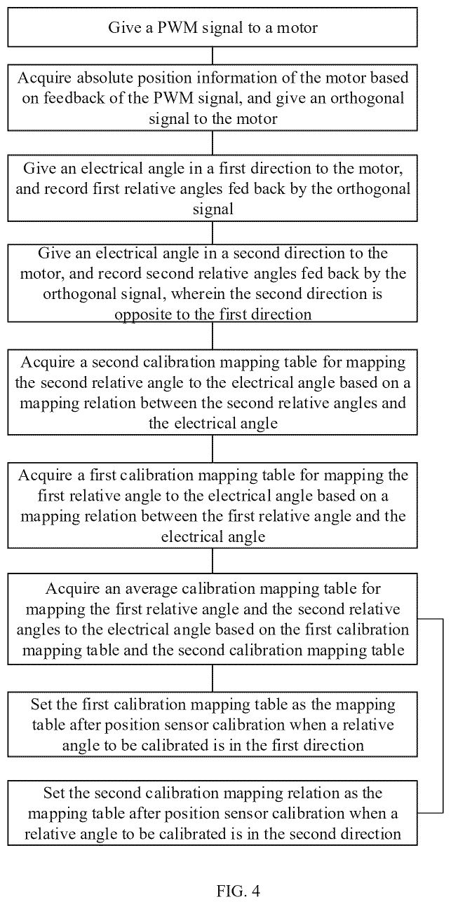

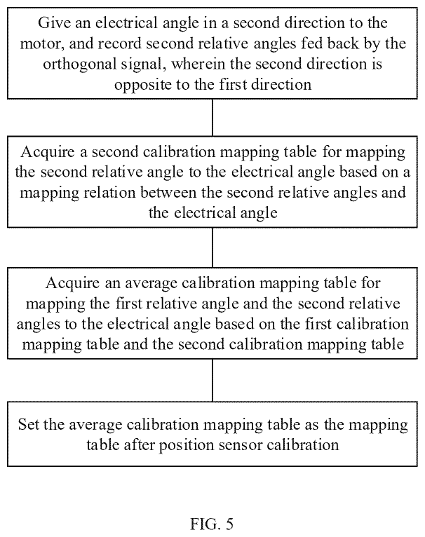

Referring to FIGS. 4-5, another embodiment of a method for calibrating a position sensor applied to a motor is provided, and comprises the following steps.

Give a PWM signal to a motor.

Acquire absolute position information of the motor based on feedback of the PWM signal, and give an orthogonal signal to the motor.

Give an electrical angle in a first direction to the motor, and record first relative angles fed back by the orthogonal signal.

Acquire a first calibration mapping table for mapping the first relative angles to the electrical angle based on a mapping relation between the first relative angles and the electrical angle.

Set the first calibration mapping table as a mapping table after position sensor calibration to perform calibration.

After giving the orthogonal signal to the motor and before outputting the angle calibration mapping table, the method further comprises the following steps.

Give the electrical angle in a second direction to the motor, and record second relative angles fed back by the orthogonal signal, wherein the second direction is opposite to the first direction.

Acquire a second calibration mapping table for mapping the second relative angles to the electrical angle based on a mapping relation between the second relative angles and the electrical angle.

The step of setting the first calibration mapping table as a mapping table after position sensor calibration comprises the following steps.

Set the first calibration mapping table as the mapping table after position sensor calibration when a relative angle to be calibrated is in the first direction.

Set the second calibration mapping relation as the mapping table after position sensor calibration when a relative angle to be calibrated is in the second direction.

In any one of the above embodiments, the method further comprises the following step.

Calculate an electrical angle corresponding to adjacent relative angles xₙ and xₙ₊₁ based on a formula

$$Y = \frac{{y}_{n + 1} - {y}_{n}}{{x}_{n + 1} - {x}_{n}} X + {y}_{n} ,$$

wherein variable X is the relative angle, variable Y is the electrical angle, and yₙ and yₙ₊₁ are respectively the electrical angles corresponding to xₙ and xₙ₊₁.

In any one of the above embodiments, the larger the electrical angle is, the more accurate the mapping table is. However, considering that the calibration time in actual production should not be too long, which may otherwise affect mass production, the electrical angle is preferably 360° to guarantee an appropriate calibration time and the accuracy of the mapping table and keep an error within an acceptable range.

In the above embodiments, the electrical angle is the angle value to which the motor is continuously reached from 0 at the same intervals, so as to obtain a series of first relative angles.

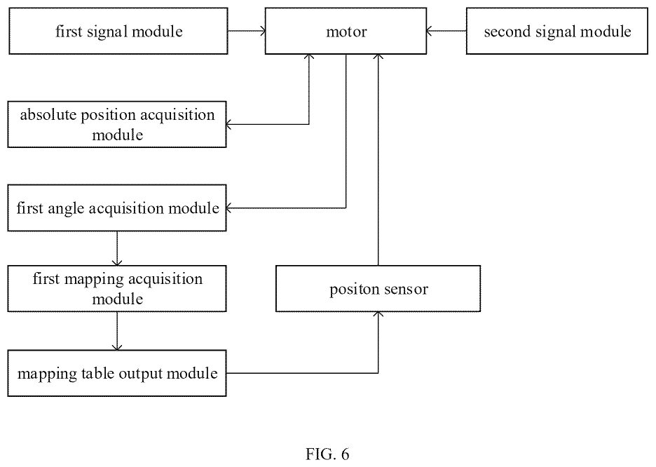

Referring to FIG. 6, a device for calibrating a position sensor applied to a motor comprises:

a first signal module adapted for giving a PWM signal to a motor;

an absolute position acquisition module adapted for acquiring absolute position information of the motor based on feedback of the PWM signal;

a second signal module adapted for giving an orthogonal signal to the motor;

a first angle acquisition module adapted for giving an electrical angle in a first direction to the motor and recording a first relative angle fed back by the orthogonal signal;

a first mapping acquisition module adapted for acquiring a first calibration mapping table for mapping the first relative angle to the electrical angle based on a mapping relation between the first relative angle and the electrical angle; and

a mapping table output module adapted for setting the first calibration mapping table as a mapping table after position sensor calibration to perform calibration.

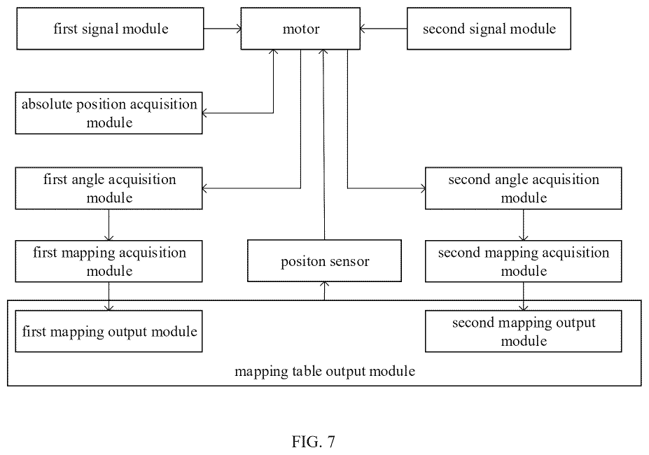

Referring to FIG. 7, in another embodiment, a device for calibrating a position sensor applied to a motor comprises:

a first signal module adapted for giving a PWM signal to a motor;

an absolute position acquisition module adapted for acquiring absolute position information of the motor based on feedback of the PWM signal;

a second signal module adapted for giving an orthogonal signal to the motor;

a first angle acquisition module adapted for giving an electrical angle in a first direction to the motor and recording first relative angles fed back by the orthogonal signal;

a first mapping acquisition module adapted for acquiring a first calibration mapping table for mapping the first relative angles to the electrical angle based on a mapping relation between the first relative angles and the electrical angle; and

a mapping table output module adapted for setting the first calibration mapping table as a mapping table after position sensor calibration to perform calibration.

The position sensor calibration device further comprises:

a second angle acquisition module adapted for giving the electrical angle of the motor in a second direction and recording second relative angles fed back by the orthogonal signal, wherein the second direction is opposite to the first direction; and

a second mapping acquisition module adapted for acquiring a second calibration mapping table for mapping the second relative angles to the electrical angle based on a mapping relation between the second relative angles and the electrical angle.

The mapping table output module comprises:

a first mapping output module adapted for setting the first calibration mapping table as the mapping table after position sensor calibration when a relative angle to be calibrated is in the first direction; and

a second mapping output module adapted for setting the second calibration mapping relation as the mapping table after position sensor calibration when a relative angle to be calibrated is in the second direction.

The electrical angle is the angle value to which the motor is continuously reached from 0 at the same intervals, so as to obtain a series of first relative angles.

In any one of the above embodiments, the larger the electrical angle is, the more accurate the mapping table is. However, considering that the calibration time in actual production should not be too long, which may otherwise affect mass production, the electrical angle is preferably 360° to guarantee an appropriate calibration time and the accuracy of the mapping table and keep an error within an acceptable range.

In the above embodiments, the electrical angle is the angle value to which the motor is continuously reached from 0 at the same intervals, so as to obtain a series of first relative angles.

The above embodiments merely expound several implementations of the invention and are specifically described in detail, but they should not be construed as limitations of the patent scope of the invention. It should be noted that those ordinarily skilled in the art can make some transformations and improvements without departing from the concept of the invention, and all these transformations and improvements should also fall within the protection scope of the invention. Therefore, the protection scope of the invention should be defined by the appended claims.

What is claimed is:

1. A method for calibrating a position sensor applied to a motor, comprising:
giving a PWM signal to a motor;
acquiring absolute position information of the motor based on feedback of the PWM signal;
giving an orthogonal signal to the motor;
giving an electrical angle in a first direction to the motor, and recording first relative angles fed back by the orthogonal signal;
acquiring a first calibration mapping table for mapping the first relative angles to the electrical angle based on a mapping relation between the first relative angles and the electrical angle; and
setting the first calibration mapping table as a mapping table after position sensor calibration to perform calibration.

2. The method for calibrating a position sensor applied to a motor according to claim 1, wherein after giving the orthogonal signal to the motor and before outputting the angle calibration mapping table, the method further comprises:
giving an electrical angle in a second direction to the motor, and recording a second relative angle fed back by the orthogonal signal, wherein the second direction is opposite to the first direction; and
acquiring a second calibration mapping table for mapping the second relative angles to the electrical angle based on a mapping relation between the second relative angles and the electrical angle;
wherein the step of setting the first calibration mapping table as a mapping table after position sensor calibration comprises:
acquiring an average calibration mapping table for mapping the first relative angles and the second relative angles to the electrical angle based on the first calibration mapping table and the second calibration mapping table; and
setting the average calibration mapping table as the mapping table after position sensor calibration.

3. The method for calibrating a position sensor applied to a motor according to claim 2, wherein the step of acquiring an average calibration mapping table for mapping the first relative angles and the second relative angles to the electrical angle comprises:
calculating third relative angles corresponding to the electrical angle in the average calibration mapping table, based on a formula
$${x}_{n} = \frac{{b}_{n} + {c}_{n}}{2} ,$$
wherein x₁ . . . xₙ are the third relative angles, b₁ . . . bₙ are the first relative angles, and c₁ . . . cₙ are the second relative angles.

4. The method for calibrating a position sensor applied to a motor according to claim 1, wherein after giving the orthogonal signal to the motor and before outputting an angle calibration mapping table, the method further comprises:
giving an electrical angle in a second direction to the motor, and recording second relative angles fed back by the orthogonal signal, wherein the second direction is opposite to the first direction; and
acquiring a second calibration mapping table for mapping the second relative angles to the electrical angle based on a mapping relation between the second relative angles and the electrical angle;
the step of setting the first calibration mapping table as a mapping table after position sensor calibration comprises:
setting the first calibration mapping table as the mapping table after position sensor calibration when a relative angle to be calibrated is in the first direction; and
setting the second calibration mapping relation as the mapping table after position sensor calibration when a relative angle to be calibrated is in the second direction.

5. The method for calibrating a position sensor applied to a motor according to claim 1, wherein the electrical angle is 360 degrees.

6. The method for calibrating a position sensor applied to a motor according to claim 1, further comprising:
calculating an electrical angle corresponding to adjacent relative angles xₙ and xₙ₊₁ according to a formula
$$Y = \frac{{y}_{n + 1} - {y}_{n}}{{x}_{n + 1} - {x}_{n}} X + {y}_{n} ,$$
wherein variable X is the relative angle, variable Y is the electrical angle, and yₙ and yₙ₊₁ are respectively the electrical angles corresponding to xₙ and xₙ₊₁.

7. A device for calibrating a position sensor applied to a motor, comprising:
a first signal module adapted for giving a PWM signal to a motor;
an absolute position acquisition module adapted for acquiring absolute position information of the motor based on feedback of the PWM signal;
a second signal module adapted for giving an orthogonal signal to the motor;
a first angle acquisition module adapted for giving an electrical angle to the motor in a first direction and recording first relative angles fed back by the orthogonal signal;
a first mapping acquisition module adapted for acquiring a first calibration mapping table for mapping the first relative angles to the electrical angle according to a mapping relation between the first relative angles and the electrical angle; and
a mapping table output module adapted for setting the first calibration mapping table as a mapping table after position sensor calibration to perform calibration.

8. The device for calibrating a position sensor applied to a motor according to claim 7, further comprising:
a second angle acquisition module adapted for giving an electrical angle in a second direction to the motor and recording second relative angles fed back by the orthogonal signal, wherein the second direction is opposite to the first direction; and
a second mapping acquisition module adapted for acquiring a second calibration mapping table for mapping the second relative angles to the electrical angle based on a mapping relation between the second relative angles and the electrical angle;
wherein the mapping table output module comprises:
a first mapping output module adapted for setting the first calibration mapping table as the mapping table after position sensor calibration when a relative angle to be calibrated is in the first direction; and
a second mapping table output module adapted for setting the second calibration mapping relation as the mapping table after position sensor calibration when a relative angle to be calibrated is in the second direction.

9. A method for calibrating a position sensor applied to a motor, comprising:
giving a PWM signal to a motor;
acquiring absolute position information of the motor based on feedback of the PWM signal;
giving an orthogonal signal to the motor;
giving an electrical angle in a first direction and/or in a second direction to the motor, and recording first relative angles and second relative angles fed back by the orthogonal signal;
acquiring a first calibration mapping table for mapping the first relative angles to the electrical angle based on a mapping relation between the first relative angles and the electrical angle, and a second calibration mapping table for mapping the second relative angles to the electrical angle based on a mapping relation between the second relative angles and the electrical angle;
acquiring an average calibration mapping table for mapping the first relative angles and the second relative angles to the electrical angle based on the first calibration mapping table and the second calibration mapping table; and
setting the first calibration mapping table and/or the second calibration mapping table and/or the average calibration mapping table as a mapping table after position sensor calibration to perform calibration;
wherein the electrical angle is the angle value to which the motor is continuously reached from 0 at the same intervals, so as to obtain a series of the first relative angles and a series of the second relative angles; and the second direction is opposite to the first direction.

10. The method for calibrating a position sensor applied to a motor according to claim 9, wherein the step of setting the first calibration mapping table and/or the second calibration mapping table and/or the average calibration mapping table as a mapping table after position sensor calibration to perform calibration comprises:
setting the first calibration mapping table as the mapping table after position sensor calibration when a relative angle to be calibrated is in the first direction; and
setting the second calibration mapping relation as the mapping table after position sensor calibration when a relative angle to be calibrated is in the second direction.

11. The method for calibrating a position sensor applied to a motor according to claim 9, wherein the electrical angle is 360 degrees.

12. The method for calibrating a position sensor applied to a motor according to claim 9, wherein the average calibration mapping table is acquired by averaging the first calibration mapping table and the second calibration mapping table.

13. The method for calibrating a position sensor applied to a motor according to claim 12, wherein the step of acquiring the average calibration mapping table comprises:
calculating third relative angles corresponding to the electrical angle in the average calibration mapping table, based on a formula
$${x}_{n} = \frac{{b}_{n} + {c}_{n}}{2} ,$$
wherein x₁ . . . xₙ are the third relative angles, b₁ . . . bₙ are the first relative angles, and c₁ . . . cₙ are the second relative angles.

14. The method for calibrating a position sensor applied to a motor according to claim 9, wherein the mapping relation between the first relative angles and the electrical angle, and the mapping relation between the first relative angles and the electrical angle are acquired by:
calculating an electrical angle corresponding to adjacent relative angles xₙ and xₙ₊₁ according to a formula
$$Y = \frac{{y}_{n + 1} - {y}_{n}}{{x}_{n + 1} - {x}_{n}} X + {y}_{n} ,$$
wherein X is the relative angle, Y is the electrical angle, and yₙ and yₙ₊₁ are respectively the electrical angles corresponding to xₙ and xₙ₊₁.
